(19) United States
(12) Patent Application Publication
(10) Pub. No.: US 2022/0150816 A1
(43) Pub. Date: May 12, 2022

(54) UPF POSITIONING FOR MOBILE EDGE COMPUTING SERVICES

(71) Applicant: T-Mobile USA, Inc., Bellevue, WA (US)

(72) Inventor: Suliman Albasheir, Sammamish, WA (US)

(21) Appl. No.: 17/095,146

(22) Filed: Nov. 11, 2020

(51) Int. Cl. H04W 48/20; H04W 48/02; H04W 24/08; H04W 68/00

(52) U.S. Cl. CPC H04W 48/20; H04W 68/005; H04W 24/08; H04W 48/02

(57) ABSTRACT

An orchestration tool facilitates establishing a user plane function (UPF) node for a wireless network at an optimal location, based on the performance of edge nodes (e.g., latency and/or throughput) at various locations. A disclosed solution includes: obtaining, by an orchestrator (the orchestration tool), UPF use case performance criteria; receiving, by the orchestrator, for a plurality of edge nodes, edge node performance values; based on at least the received edge node performance values, selecting a first edge node from the plurality of edge nodes; and generating an alert indicating the selection of the first edge node. A first UPF will be built at the first edge node although, in some examples, upon further monitoring, the orchestrator may determine that the second edge node outperforms the first edge node, resulting in the UPF moving to the second edge node. In some examples, performance criteria depend on traffic type (e.g., real-time gaming).

### BACKGROUND

In mobile edge computing (MEC), resources are located relatively close to end users and/or internet of things (IoT) endpoints in an attempt to optimize performance for low latency and/or high bandwidth (high throughput) services, such as real time gaming and augmented reality (AR). In 5G, cellular devices (e.g., user equipment, UEs) connect to network computing resources via a data network, such as a portion of the internet or another network. Wireless UEs reach the data network via a wireless connection to a wireless network node (e.g., a gNB or gNodeB), and then through a user plane function (UPF).

In some scenarios, UPF position relative to the wireless network node may have a significant impact on end-to-end (E2E) performance, for example, affecting latency and/or throughput. Positioning a UPF in a sub-optimal location may then result in degraded user experiences. In some scenarios, UPFs may be deployed “on the fly.” Without an E2E service orchestration system that knows where to place or position the UPF to ensure that the lowest latency achieved and/or highest throughput is achieved, the investment of building a new UPF is at risk.

### SUMMARY

The following summary is provided to illustrate examples disclosed herein, but is not meant to limit all examples to any particular configuration or sequence of operations.

An orchestration tool facilitates establishing a user plane function (UPF) node for a wireless network at an optimal location, based on the performance of edge nodes (e.g., latency and/or throughput) at various locations. A disclosed solution includes: obtaining, by an orchestrator (the orchestration tool), UPF use case performance criteria; receiving, by the orchestrator, for a plurality of edge nodes, edge node performance values; based on at least the received edge node performance values, selecting a first edge node from the plurality of edge nodes; and generating an alert indicating the selection of the first edge node. A first UPF will be built at the first edge node although, in some examples, upon further monitoring, the orchestrator may determine that the second edge node outperforms the first edge node, resulting in the UPF moving to the second edge node. In some examples, performance criteria depend on traffic type (e.g., real-time gaming or augmented reality).

### BRIEF DESCRIPTION OF THE DRAWINGS

The disclosed examples are described below with reference to the accompanying drawing figures listed below, wherein:

FIG. 1 illustrates an exemplary arrangement that advantageously determines optimal user plane function (UPF) positioning for mobile edge computing (MEC) services;

FIG. 2 illustrates further detail for the arrangement of FIG. 1;

FIG. 3 illustrates a flowchart of exemplary operations associated with the arrangement of FIG. 1;

FIG. 4 illustrates another flowchart of exemplary operations associated with the arrangement of FIG. 1; and

FIG. 5 illustrates a block diagram of a computing device that may be used as a component of the arrangement illustrated in FIG. 1.

Corresponding reference characters indicate corresponding parts throughout the drawings. References made throughout this disclosure. relating to specific examples, are provided for illustrative purposes, and are not meant to limit all implementations or to be interpreted as excluding the existence of additional implementations that also incorporate the recited features.

### DETAILED DESCRIPTION

An orchestration tool facilitates establishing a user plane function (UPF) node for a wireless network at an optimal location, based on the performance of edge nodes (e.g., latency and/or throughput) at various locations. A disclosed solution includes: obtaining, by an orchestrator (the orchestration tool), UPF use case performance criteria; receiving, by the orchestrator, for a plurality of edge nodes, edge node performance values; based on at least the received edge node performance values, selecting a first edge node from the plurality of edge nodes; and generating an alert indicating the selection of the first edge node. A first UPF will be built at the first edge node although, in some examples, upon further monitoring, the orchestrator may determine that the second edge node outperforms the first edge node, resulting in the UPF moving to the second edge node. In some examples, performance criteria depend on traffic type (e.g., real-time gaming or augmented reality).

A disclosed tool (an orchestrator) improves the speed of cellular networks (e.g., reduced latency and/or higher throughput) by selecting an edge node from a plurality of edge nodes, at which to build a UPF, based on at least edge node performance values (for the plurality of edge nodes). Using the tool improves end-to-end (E2E) service orchestration when spinning up mobile edge computing (MEC) services by optimally positioning UPFs (needed to run the user-plane of the end users) to meet different requirements of services being deployed. The orchestrator determines the performance of various edge computing nodes that are in the vicinity of an expected surge in network traffic. Upon receiving (or determining) performance criteria, such as latency and throughput thresholds, an edge node is selected for building out a UPF node. This removes guesswork of identifying the best (optimal) location for the new UPF. After the UPF is in place and operating, the tool may continue to monitor the UPF performance. If the UPF performance degrades, and a second edge node has sufficient performance, the UPF node may be moved from the first edge node to the second edge node. This proactive monitoring permits the UPF to be moved when necessary, to maintain a high quality of experience for deployed services.

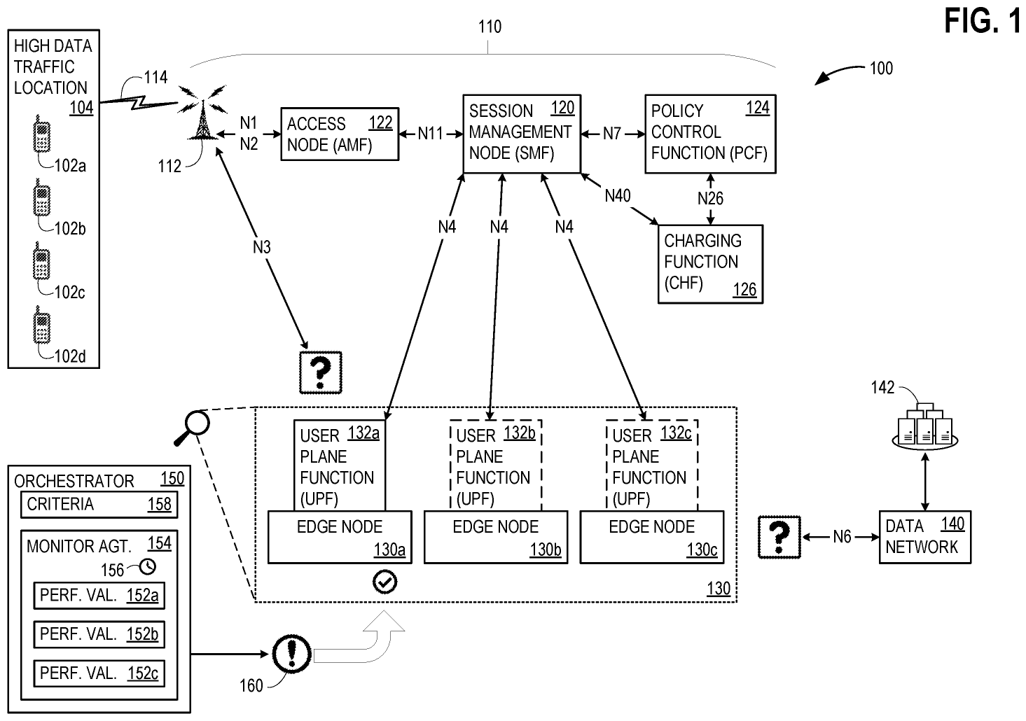

FIG. 1 illustrates an exemplary arrangement 100 that uses an orchestrator 150 to advantageously determine optimal UPF positioning for MEC services over a wireless network 110 (e.g., a 5G cellular network). A plurality of user equipment devices (UEs) 102a, 102b, 102c, and 102d are located in (or are predicted to be located in) a high data traffic location 104. In an example scenario, a new real-time gaming, virtual reality (VR), or augmented reality (AR) activity is planned to begin operating at high data traffic location 104. The activity will be using UEs 102a, 102b, 102c, and 102d, which connect to wireless network 110 via a wireless network node 112, using an air interface 114. A surge in data traffic through wireless network node 112 is therefore expected, which will pass through a UPF in order to reach a data network 140. The service endpoint target for the data traffic is a network resource 142, for example a computational or storage resource that handles real-time gaming, VR, and/or AR data. In some examples, wireless network node 112 comprises a radio access network (RAN) node, such as a gNodeB (network equipment that transmits and receives wireless communications between UE and a mobile network, also known as gNB).

Wireless network node 112 is supported by a session management function (SMF) node 120, via an Access and Mobility Management Function (AMF) node 122. SMF node 120 uses a policy charging function (PCF) node 124 and a charging function (CHF) node 126 to provide services to UEs 102a, 102b, 102c, and 102d. Data traffic between each of UEs 102a, 102b, 102c, and 102d (e.g., through wireless network node 112) and AMF node 122 may use an N1 and/or an N2 interface. Data traffic between AMF node 122 and SMF node 120 may use an N11 interface; data traffic between SMF node 120 and PCF node 124 may use an N7 interface; data traffic between SMF node 120 and CHF node 126 may use an N40 interface; and data traffic between PCF node 124 and CHF node 126 may uses an N26 interface.

To handle the surge in data traffic through wireless network node 112 to data network 140, a new UPF will be needed. Data traffic between wireless network node 112 and the new UPF node may use an N3 interface; data traffic between SMF node 120 and the new UPF node may use an N4 interface; and data traffic between data network 140 and the new UPF node may use an N6 interface. A plurality of candidate locations for the new UPF node exist at each of a plurality of edge nodes 130, for example edge node 130a, edge node 130b, and edge node 130c. Although three edge nodes are illustrated, it should be understood that a different number of edge nodes may serve as candidate locations for the new UPF node.

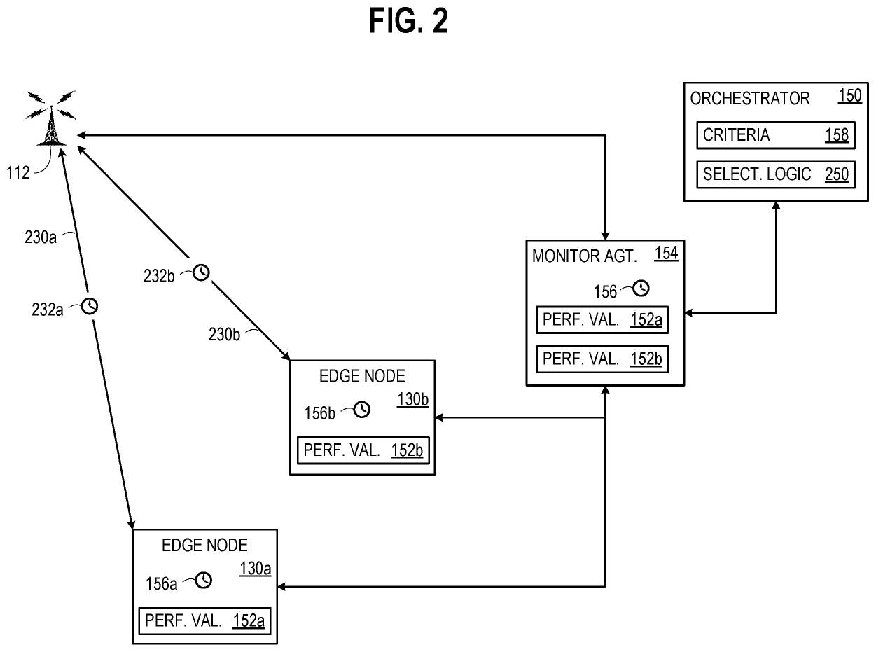

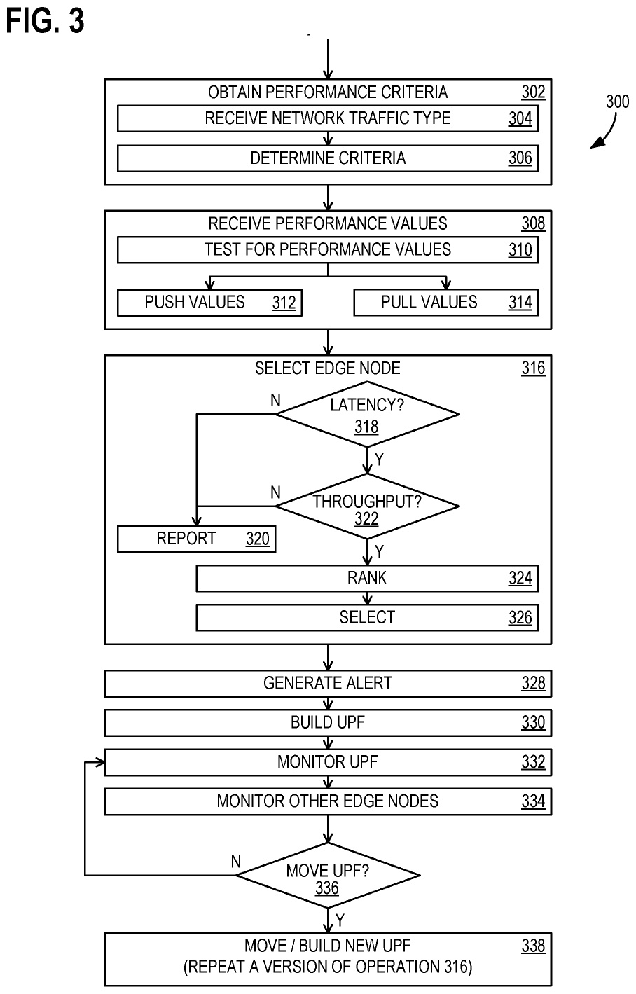

As will be described in further detail in relation to FIGS. 2 and 3, an orchestrator 150 selects an edge node (e.g., edge node 130a) from plurality of edge nodes 130, and generates an alert 160 indicating the selection of the edge node. To accomplish this orchestrator 150 receives or determines UPF use case performance criteria 158, which is the performance needed for the use case (or use cases) that is expected to be run on the new UPF. Some use cases may require low latency, some may require high throughput, and some may require both. In some examples, UPF use case performance criteria 158 may include the most stringent criteria for a plurality of predicted use cases. In some examples, receiving or determining UPF use case performance criteria 158 may include either direct input of UPF use case performance criteria 158 or determination (e.g., using a look-up table) of UPF use case performance criteria 158 based on at least the type of network traffic to be supported. UPF use case performance criteria 158 may include latency and/or throughput preferences or thresholds. A monitoring agent 154 tests or otherwise receives key performance indicators (KPIs) for each of edge nodes 130a, 130b, and 130c, and stores them as edge node performance values 152a, 152b, and 152c, respectively. Edge node performance values 152a, 152b, and 152c may be determined using a testing function 156 that calculates elapsed times for test signals to pass between wireless network node 112 and each of edge nodes 130a, 130b, and 130c.

In some examples, orchestrator 150 monitors each of edge nodes 130a, 130b, and 130c over time, in order to determine both long-term performance averages and performance degradation history (e.g., frequency and duration of outages). If orchestrator 150 selects edge node 130a, the new UPF node will be built as UPF node 132a at edge node 130a; if orchestrator 150 selects edge node 130b, the new UPF node will be built as UPF node 132b at edge node 130b; and if orchestrator 150 selects edge node 130c, the new UPF node will be built as UPF node 132c at edge node 130c.

At the point in time illustrated in FIG. 1, orchestrator 150 has selected edge node 130a, although the connections to wireless network node 112 and data network 140 have not yet been established. In some examples, orchestrator 150 will continue monitoring different KPIs of the running service and relocate the UPF deployment in case the quality of experience based on the collected KPIs deteriorates.

FIG. 2 illustrates further detail regarding the determination of for edge node performance values. For clarity, only edge nodes 130a and 130b are shown; the process for edge node 130c is similar as described below. As illustrated in FIG. 2, monitoring agent 154 is external to orchestrator 150, although in some examples, orchestrator 150 comprises monitoring agent 154. A test signal 230a is sent between wireless network node 112 and edge node 130a. Time information 232a is collected and used to determine edge node performance values 152a. Edge node performance values 152a may include latency and/or throughput values from wireless network node 112 to edge node 130a, from edge node 130a to wireless network node 112, and/or round trip. Other KPIs, such as outage frequency and durations, and bit error rate (BER) may also be included. Similarly, test signal 230b is sent between wireless network node 112 and edge node 130b. Time information 232b is collected and used to determine edge node performance values 152b, which may have values corresponding to those of edge node performance values 152b.

In some examples, testing function 156, within monitoring agent 154, determines both edge node performance values 152a and 152b, and initiates the testing. In some examples, a testing function 156a, within edge node 130a, determines edge node performance values 152a and a testing function 156b, within edge node 130b, determines edge node performance values 152b. When edge nodes 130a and 130b collect their own performance values, monitoring agent 154 (or orchestrator 150) requests the performance values from edge nodes 130a and 130b. In some examples, monitoring agent 154 obtains at least some of the performance value information (e.g., some of time information 232a and 232b) from wireless network node 112.

In some examples, monitoring agent 154 pushes edge node performance values 152a and 152b to orchestrator 150, such as on a schedule. In some examples, orchestrator 150 requests (pulls) edge node performance values 152a and 152b from monitoring agent 154. Orchestrator 150 uses selection logic 250 to perform the selection of the edge node for the new UPF node.

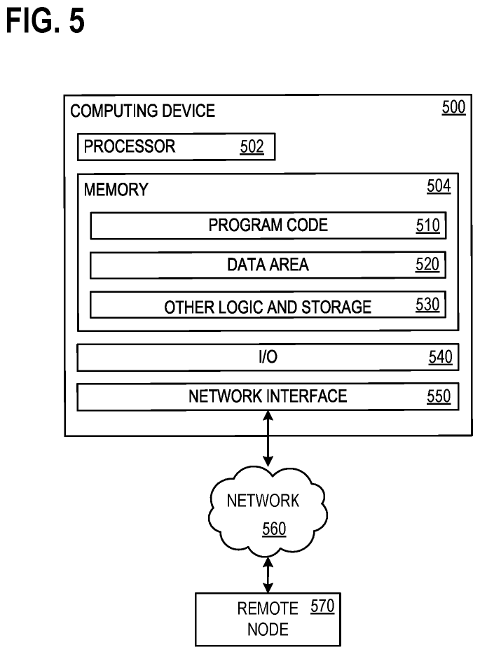

FIG. 3 illustrates a flowchart 300 of exemplary operations associated with establishing a UPF node for wireless network 110. In some examples, at least a portion of flowchart 300 may be performed using one or more computing devices 500 of FIG. 5. In some examples, wireless network 110 comprises a 5G cellular network. Flowchart 300 commences with operation 302, which includes obtaining, by orchestrator 150, UPF use case performance criteria 158. In some examples, operation 302 includes operations 304 and 306. Operation 304 includes receiving an indication of a type of network traffic to be supported. In some examples, the type of network traffic to be supported comprises real-time gaming, VR, AR, and/or streaming video.

Operation 306 includes, based on at least the type of network traffic to be supported, determining UPF use case performance criteria 158. In some examples, UPF use case performance criteria 158 comprise an indication of a latency preference and/or an indication of a throughput preference. In some examples, the latency preference comprises a latency value preference between an edge node and a wireless network node in communication with a wireless UE. In some examples, the latency preference comprises a latency value threshold. In some examples, the latency value threshold is set to a value of 10 milliseconds or less. In some examples, the throughput preference comprises a throughput value preference between an edge node and a wireless network node in communication with a wireless UE. In some examples, the throughput preference comprises a throughput value threshold. In some examples, wireless network node 112 comprises a gNodeB.

Operation 308 includes receiving, by orchestrator 150, for plurality of edge nodes 130 (e.g., edge node 130a, edge node 130b, and edge node 130c), edge node performance values 152a, 152b, and 152c. In some examples, orchestrator 150 comprises monitoring agent 154. In some examples, monitoring agent 154 is external to orchestrator 150. Operation 308 includes multiple actions, shown as operations 310-314. Operation 310 includes testing, by monitoring agent 154 (which is associated with orchestrator 150), plurality of edge nodes 130 to determine edge node performance values 152a, 152b, and 152c. In some examples, at least one edge node within plurality of edge nodes 130 determines its own performance values. In such examples, receiving, by orchestrator 150, edge node performance values 152a, 152b, and 152c comprises requesting edge node performance values 152a, 152b, and 152c from plurality of edge nodes 130. In some examples, requesting edge node performance values 152a, 152b, and 152c from plurality of edge nodes 130 comprises requesting, by monitoring agent 154, edge node performance values 152a, 152b, and 152c from plurality of edge nodes 130.

Multiple options are available to get edge node performance values 152a, 152b, and 152c to orchestrator 150. One option, operation 312, includes pushing, by monitoring agent 154, to orchestrator 150, edge node performance values 152a, 152b, and 152c. Another option, operation 314 includes requesting, by orchestrator 150, from monitoring agent 154, edge node performance values 152a, 152b, and 152c. Operation 314 is a pull operation. In some examples, receiving, by orchestrator 150, edge node performance values 152a, 152b, and 152c comprises requesting edge node performance values 152a, 152b, and 152c from plurality of edge nodes 130. In some examples, requesting edge node performance values 152a, 152b, and 152c from plurality of edge nodes 130 comprises requesting, by monitoring agent 154, edge node performance values 152a, 152b, and 152c from plurality of edge nodes 130.

The selection of the edge node for the new UPF is performed in operation 316, which includes based on at least the received edge node performance values, selecting a first edge node (e.g., edge node 130a) from plurality of edge nodes 130. In some examples, selecting the first edge node comprises ranking the received edge node performance values, and selecting the first edge node based on the ranking. In some examples, selecting the first edge node comprises determining whether the received edge node performance values for the first edge node meets the latency value threshold, and based on at least determining that the received edge node performance values for the first edge node meets the latency value threshold, selecting the first edge node. In some examples, selecting the first edge node comprises determining whether the received edge node performance values for the first edge node meets the throughput value threshold, and based on at least determining that the received edge node performance values for the first edge node meets the throughput value threshold, selecting the first edge node. These are accomplished using operations 318-326.

Decision operation 318 includes determining whether the received edge node performance values for the first edge node meets the latency value threshold. If not, a report may be issued in operation 320, to alert network operators or other maintainers. If the latency threshold is met, decision operation 322 includes determining whether the received edge node performance values for the first edge node meets the throughput value threshold. If not, a report may be issued in operation 320, to alert network operators or other maintainers. If the throughput threshold is met, operation 324 includes ranking the received edge node performance values. Operation 326 then includes selecting the first edge node based on the ranking. Operation 326 therefore may include one or more of the following features: based on at least determining that the received edge node performance values for the first edge node meets the latency value threshold, selecting the first edge node; and based on at least determining that the received edge node performance values for the first edge node meets the throughput value threshold, selecting the first edge node.

Operation 328 includes generating alert 160 indicating the selection of the first edge node. Operation 330 includes building a first UPF node at the first edge node (e.g., building UPF node 132a at edge node 130a). Operations 332 and 334 provide ongoing monitoring, in order to determine whether first UPF node should be moved. Operation 332 includes monitoring UPF node performance values for the first UPF node at the first edge node, and operation 334 includes monitoring edge node performance values for a remainder portion of plurality of edge nodes 130 (e.g., edge nodes 130b and 130c). Operations 332 and 334 may use the same test, push, and pull options as described above for operation 308.

Decision operation 336 includes, based on at least UPF use case performance criteria 158, determining that a second edge node of plurality of edge nodes 130 outperforms the first edge node (e.g., edge node 130b outperforms edge node 130a). Decision operation 336 is used to determine whether to move the UPF, and may follow a process similar to that described above for operation 316. In some examples, decision operation 336 includes receiving user input. For example, if edge node 130b outperforms edge node 130a, but the KPIs for edge node 130a are still acceptable (e.g., meeting UPF use case performance criteria 158), then the user (whose use case drove the need for the new UPF) may optionally request that the UPF location move to the better-performing node. However, if the KPIs for edge node 130a are no longer acceptable (e.g., failing to meet UPF use case performance criteria 158), then the UPF location moves to the better-performing node without waiting for feedback from the user about poor network performance.

If a move is not warranted, flowchart 300 returns to monitoring at operation 332. Otherwise, if a move is warranted, operation 338 includes, based on at least determining that the second edge node outperforms the first edge node, building a second UPF node at the second edge node. Operation 338 may include a version of operation 316, in which each of the nodes is checked for acceptable performance and ranked prior to selecting the new location for building the second UPF. In some examples, the second UPF is an additional UPF. In some examples, the second UPF replaces the UPF (e.g., the UPF is moved). In scenarios involving moving, rather than adding, a UPF, operation 338 also includes, based at least on building the second UPF node at the second edge node, removing the first UPF node. That is, building the second UPF node at the second edge node comprises moving the first UPF node from the first edge node to the second edge node.

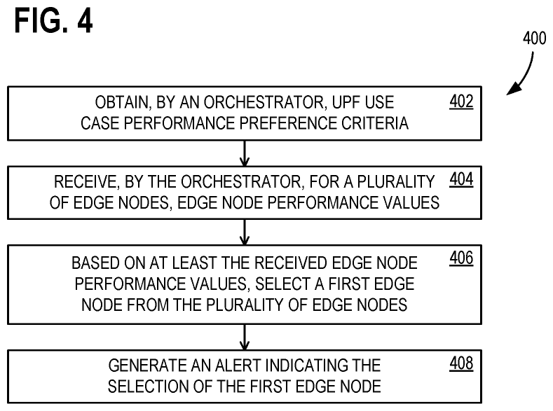

FIG. 4 illustrates a flowchart 400 of exemplary operations associated with establishing a UPF node for a wireless network. In some examples, at least a portion of flowchart 400 may be performed using one or more computing devices 500 of FIG. 5. Operation 402 includes obtaining, by an orchestrator, UPF use case performance criteria. Operation 404 includes receiving, by the orchestrator, for a plurality of edge nodes, edge node performance values. Operation 404 includes based on at least the received edge node performance values, selecting a first edge node from the plurality of edge nodes. Operation 408 includes generating an alert indicating the selection of the first edge node.

FIG. 5 illustrates a block diagram of computing device 500 that may be used as a component of arrangement 100 of FIG. 1, for example, as any component described herein that may require computational or storage capacity. Computing device 500 has at least a processor 502 and a memory 504 that holds program code 510, data area 520, and other logic and storage 530. Memory 504 is any device allowing information, such as computer executable instructions and/or other data, to be stored and retrieved. For example, memory 504 may include one or more random access memory (RAM) modules, flash memory modules, hard disks, solid-state disks, persistent memory devices, and/or optical disks. Program code 510 comprises computer executable instructions and computer executable components including any instructions necessary to perform operations described herein. Data area 520 holds any data necessary to perform operations described herein. Memory 504 also includes other logic and storage 530 that performs or facilitates other functions disclosed herein or otherwise required of computing device 500. An input/output (I/O) component 540 facilitates receiving input from users and other devices and generating displays for users and outputs for other devices. A network interface 550 permits communication over a network 560 with a remote node 570, which may represent another implementation of computing device 500. For example, a remote node 570 may represent another of the above-noted nodes within arrangement 100.

### Additional Examples

An exemplary system for establishing a UPF node for a wireless network comprises: a processor; and a computer-readable medium storing instructions that are operative upon execution by the processor to: obtain, by an orchestrator, UPF use case performance criteria; receive, by the orchestrator, for a plurality of edge nodes, edge node performance values; based on at least the received edge node performance values, select a first edge node from the plurality of edge nodes; and generate an alert indicating the selection of the first edge node.

An exemplary method of establishing a UPF node for a wireless network comprises: obtaining, by an orchestrator, UPF use case performance criteria; receiving, by the orchestrator, for a plurality of edge nodes, edge node performance values; based on at least the received edge node performance values, selecting a first edge node from the plurality of edge nodes; and generating an alert indicating the selection of the first edge node.

One or more exemplary computer storage devices has computer-executable instructions stored thereon which, on execution by a computer, cause the computer to perform operations comprising: obtaining, by an orchestrator, UPF use case performance criteria; receiving, by the orchestrator, for a plurality of edge nodes, edge node performance values; based on at least the received edge node performance values, selecting a first edge node from the plurality of edge nodes; and generating an alert indicating the selection of the first edge node.

Alternatively, or in addition to the other examples described herein, examples include any combination of the following:
building a first UPF node at the first edge node;
monitoring UPF node performance values for a first UPF node at the first edge node;
monitoring edge node performance values for a remainder portion of the plurality of edge nodes;
based on at least the UPF use case performance criteria, determining that a second edge node of the plurality of edge nodes outperforms the first edge node;
based on at least determining that the second edge node outperforms the first edge node, building a second UPF node at the second edge node;
the UPF use case performance criteria comprises an indication of a latency preference and/or an indication of a throughput preference;
receiving an indication of a type of network traffic to be supported;
based on at least the type of network traffic to be supported, determining the UPF use case performance criteria;
receiving the UPF use case performance criteria comprises receiving an indication of a type of network traffic to be supported, and based on at least the type of network traffic to be supported, determining the UPF use case performance criteria;
testing, by a monitoring agent associated with the orchestrator, the plurality of edge nodes to determine the edge node performance values;
receiving, by the orchestrator, the edge node performance values comprises requesting the edge node performance values from the plurality of edge nodes;
the wireless network comprises a 5G cellular network;
the wireless network node comprises a gNodeB;
the latency preference comprises a latency value preference between an edge node and a wireless network node in communication with a wireless UE;
the latency preference comprises a latency value threshold;
the latency value threshold is set to a value of 10 milliseconds or less;
the throughput preference comprises a throughput value preference between an edge node and a wireless network node in communication with a wireless UE;
the throughput preference comprises a throughput value threshold;
the type of network traffic to be supported comprises real-time gaming, VR, AR, and/or streaming video;
ranking the received edge node performance values;
selecting the first edge node based on the ranking;
selecting the first edge node comprises ranking the received edge node performance values, and selecting the first edge node based on the ranking;
determining whether the received edge node performance values for the first edge node meets the latency value threshold;
based on at least determining that the received edge node performance values for the first edge node meets the latency value threshold, selecting the first edge node;
selecting the first edge node comprises determining whether the received edge node performance values for the first edge node meets the latency value threshold, and based on at least determining that the received edge node performance values for the first edge node meets the latency value threshold, selecting the first edge node;
determining whether the received edge node performance values for the first edge node meets the throughput value threshold;
based on at least determining that the received edge node performance values for the first edge node meets the throughput value threshold, selecting the first edge node;
selecting the first edge node comprises determining whether the received edge node performance values for the first edge node meets the throughput value threshold, and based on at least determining that the received edge node performance values for the first edge node meets the throughput value threshold, selecting the first edge node;
the orchestrator comprises the monitoring agent;
the monitoring agent is external to the orchestrator;
pushing, by the monitoring agent, to the orchestrator, the edge node performance values;
monitoring UPF node performance values for the first UPF node comprises pushing, by the monitoring agent, to the orchestrator, the UPF node performance values;
requesting, by the orchestrator, from the monitoring agent, the edge node performance values;
monitoring UPF node performance values for the first UPF node comprises requesting, by the orchestrator, from the monitoring agent, the UPF node performance values;
requesting the edge node performance values from the plurality of edge nodes comprises requesting, by the monitoring agent, the edge node performance values from the plurality of edge nodes;
at least one edge node within the plurality of edge nodes determines its own performance values;
based at least on building the second UPF node at the second edge node, removing the first UPF node;
building the second UPF node at the second edge node comprises moving the first UPF node from the first edge node to the second edge node;
a first UPF node at the first edge node; and
a second UPF node at the second edge node.

The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation is within the scope of aspects of the disclosure. It will be understood that the benefits and advantages described above may relate to one embodiment or may relate to several embodiments. When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of.”

Having described aspects of the disclosure in detail, it will be apparent that modifications and variations are possible without departing from the scope of aspects of the disclosure as defined in the appended claims. As various changes may be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A method of establishing a user plane function (UPF) node for a wireless network, the method comprising:
obtaining, by an orchestrator, UPF use case performance criteria;
receiving, by the orchestrator, for a plurality of edge nodes, edge node performance values;
based on at least the received edge node performance values, selecting a first edge node from the plurality of edge nodes; and
generating an alert indicating the selection of the first edge node.

2. The method of claim 1, further comprising:
building a first UPF node at the first edge node.

3. The method of claim 1, further comprising:
monitoring UPF node performance values for a first UPF node at the first edge node;
monitoring edge node performance values for a remainder portion of the plurality of edge nodes;
based on at least the UPF use case performance criteria, determining that a second edge node of the plurality of edge nodes outperforms the first edge node; and
based on at least determining that the second edge node outperforms the first edge node, building a second UPF node at the second edge node.

4. The method of claim 1, wherein the UPF use case performance criteria comprises an indication of a latency preference and/or an indication of a throughput preference.

5. The method of claim 1, wherein receiving the UPF use case performance criteria comprises:
receiving an indication of a type of network traffic to be supported; and
based on at least the type of network traffic to be supported, determining the UPF use case performance criteria.

6. The method of claim 1, further comprising:
testing, by a monitoring agent associated with the orchestrator, the plurality of edge nodes to determine the edge node performance values.

7. The method of claim 1, wherein receiving, by the orchestrator, the edge node performance values comprises requesting the edge node performance values from the plurality of edge nodes.

8. A system for establishing a user plane function (UPF) node for a wireless network, the system comprising:
a processor; and
a computer-readable medium storing instructions that are operative upon execution by the processor to:
obtain, by an orchestrator, UPF use case performance criteria;
receive, by the orchestrator, for a plurality of edge nodes, edge node performance values;
based on at least the received edge node performance values, select a first edge node from the plurality of edge nodes; and
generate an alert indicating the selection of the first edge node.

9. The system of claim 8, wherein the system further comprises a first UPF node at the first edge node.

10. The system of claim 8, wherein the operations are further operative to:
monitor UPF node performance values for a first UPF node at the first edge node;
monitor edge node performance values for a remainder portion of the plurality of edge nodes; and
based on at least the UPF use case performance criteria, determine that a second edge node of the plurality of edge nodes outperforms the first edge node; and
wherein the system further comprises:
a second UPF node at the second edge node.

11. The system of claim 8, wherein the UPF use case performance criteria comprises an indication of a latency preference and/or an indication of a throughput preference.

12. The system of claim 8, wherein receiving the UPF use case performance criteria comprises:
receiving an indication of a type of network traffic to be supported; and
based on at least the type of network traffic to be supported, determining the UPF use case performance criteria.

13. The system of claim 8, wherein the operations are further operative to:
test, by a monitoring agent associated with the orchestrator, the plurality of edge nodes to determine the edge node performance values.

14. The system of claim 8, wherein receiving, by the orchestrator, the edge node performance values comprises requesting the edge node performance values from the plurality of edge nodes.

15. One or more computer storage devices having computer-executable instructions stored thereon which, on execution by a computer, cause the computer to perform operations comprising:
obtaining, by an orchestrator, user plane function (UPF) performance criteria;
receiving, by the orchestrator, for a plurality of edge nodes, edge node performance values;
based on at least the received edge node performance values, selecting a first edge node from the plurality of edge nodes; and
generating an alert indicating the selection of the first edge node.

16. The one or more computer storage devices of claim 15, wherein the operations further comprise:
monitoring UPF node performance values for a first UPF node at the first edge node;
monitoring edge node performance values for a remainder portion of the plurality of edge nodes; and
based on at least the UPF use case performance criteria, determining that a second edge node of the plurality of edge nodes outperforms the first edge node.

17. The one or more computer storage devices of claim 15, wherein the UPF use case performance criteria comprises an indication of a latency preference and/or an indication of a throughput preference.

18. The one or more computer storage devices of claim 15, wherein receiving the UPF use case performance criteria comprises:
receiving an indication of a type of network traffic to be supported; and
based on at least the type of network traffic to be supported, determining the UPF use case performance criteria.

19. The one or more computer storage devices of claim 15, wherein the operations further comprise:
testing, by a monitoring agent associated with the orchestrator, the plurality of edge nodes to determine the edge node performance values.

20. The one or more computer storage devices of claim 15, wherein receiving, by the orchestrator, the edge node performance values comprises requesting the edge node performance values from the plurality of edge nodes.
